(19) United States
(12) Patent Application Publication
(10) Pub. No.: US 2014/0176741 A1
(43) Pub. Date: Jun. 26, 2014

(54) CAMERA ACTUATOR

(71) Applicant: HON HAI PRECISION INDUSTRY CO., LTD., New Taipei (TW)

(72) Inventor: CHANG-WEI KUO, New Taipei (TW)

(73) Assignee: HON HAI PRECISION INDUSTRY CO., LTD., New Taipei (TW)

(21) Appl. No.: 13/963,063

(22) Filed: Aug. 9, 2013

(30) Foreign Application Priority Data
Dec. 26, 2012 (TW) 101150274

(51) Int. Cl. H04N 5/232; H04N 5/225

(52) U.S. Cl. CPC H04N 5/2328; H04N 5/2253
USPC 348/208.7

(57) ABSTRACT

A camera actuator includes a moveable carrier, a metal tube, an image sensor carrying plate, and a metallic guide pin. The moveable carrier includes a first bushing hole and a second bushing hole. The first bushing hole is aligned with the second bushing hole. The metal tube is a hollow cylinder and arranged in the first bushing hole and the second bushing hole. The image sensor carrying plate comprises a through hole; the metallic guide pin comprises a first end and a second end, the first end is fixed in the through hole, and the second end is inserted into the metal tube.

### BACKGROUND

1. Technical Field

The present disclosure relates to camera actuators.

2. Description of Related Art

Camera actuators are used to perform auto-focus functions. A camera actuator includes a moveable carrier and a guide pin. The moveable carrier defines a bushing hole. The guide pin extends through the bushing hole and moves lenses along an optical axis of the camera to realize the auto-focus function. However, the moveable carrier is made of plastic and the guide pin is made of metal. The guide pin can grind the moveable carrier and enlarge the bushing hole when moving in the bushing hole, and a dynamic tilt angle becomes greater. This affects the auto-focus function.

Therefore, it is desired to provide a camera actuator which can overcome the above mentioned problems.

### BRIEF DESCRIPTION OF THE DRAWINGS

FIG. 1 is a schematic, isometric view of a camera actuator according to an exemplary embodiment.

FIG. 2 is an exploded view of the camera actuator of FIG. 1.

FIG. 3 is similar to FIG. 1, but a housing of the camera actuator is removed.

FIG. 4 is a schematic, isometric view of the housing of the camera actuator of FIG. 1.

### DETAILED DESCRIPTION

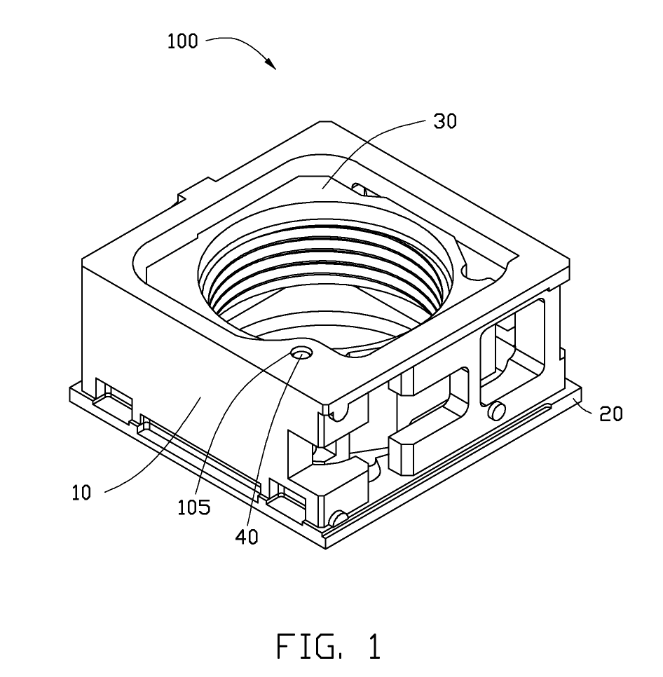

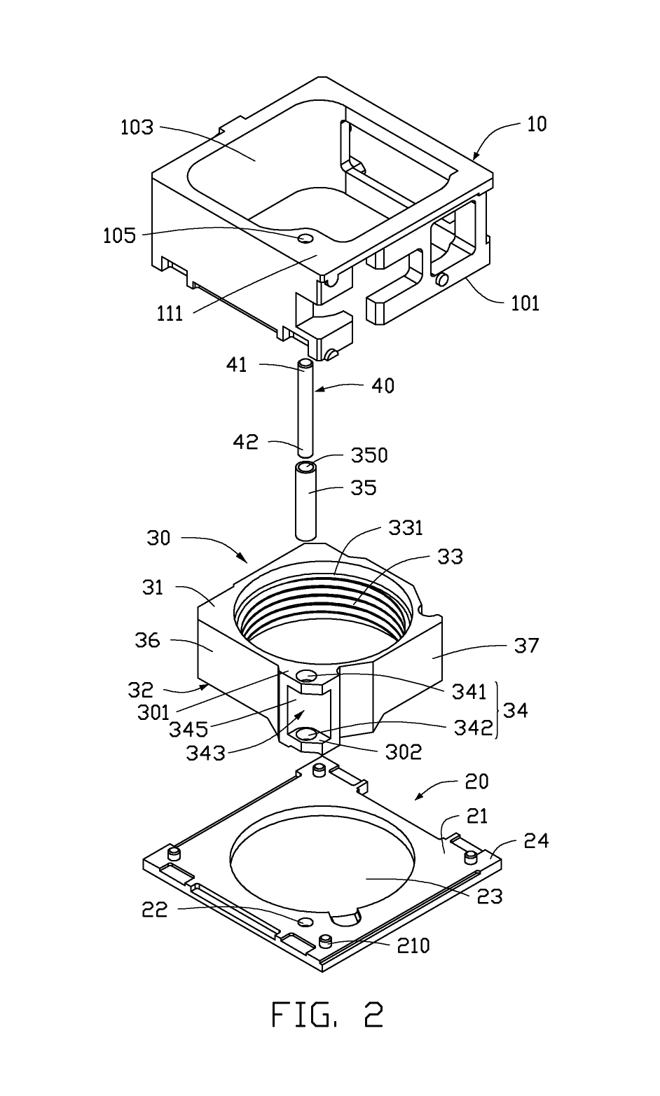

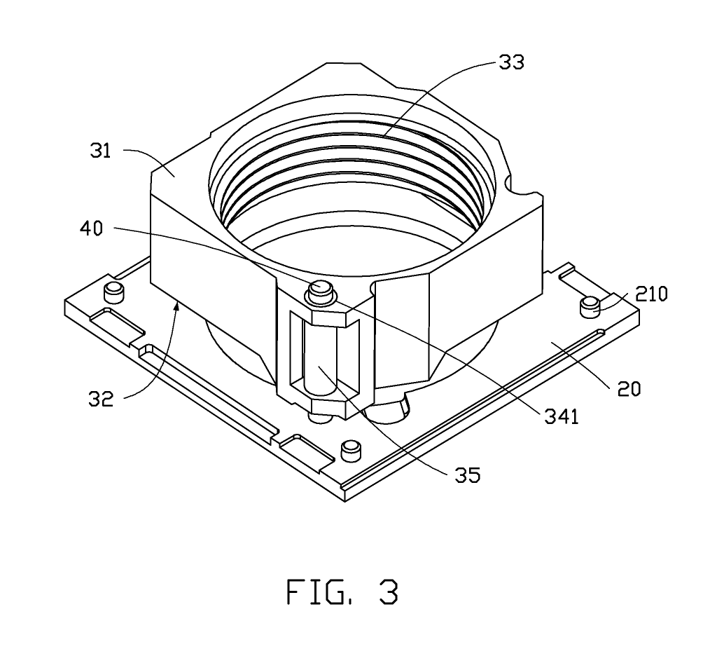

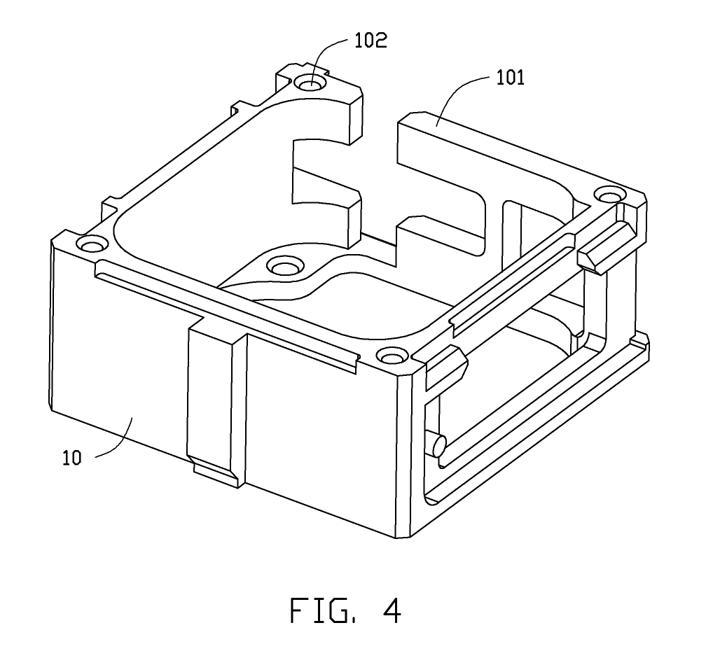

FIGS. 1-4 show a camera actuator 100 according to an exemplary embodiment. The camera actuator 100 includes a housing 10, an image sensor carrying plate 20, a moveable carrier 30, a metal tube 35, and a metallic guide pin 40.

The housing 10 is arranged outside of the moveable carrier 30 and on the image sensor carrying plate 20. The housing 10 is a four-sided frame and defines a hole 103 in the center thereof. The moveable carrier 30 is received in the hole 103. The housing 10 includes a first end surface 101 and a second end surface 111 at opposite sides of the housing 10. The first end surface 101 is close to the image sensor carrying plate 20 and the first end surface 101 defines a recess 102 at each corner of the housing 10. The second end surface 111 defines a receiving hole 105 adjacent to the hole 103.

The image sensor carrying plate 20 defines a circular hole 23 in the center thereof. The image sensor carrying plate 20 includes a third end surface 21 close to the moveable carrier 30. The image sensor carrying plate 20 further includes a number of protrusions 210 extending away from the third end surface 21 and defines a through hole 22. The through hole 22 is adjacent to the circular hole 23 and is aligned with the receiving hole 105. The protrusion 210 is arranged at each corner 24 of the image sensor carrying plate 20. The protrusion 210 matches with the recess 102 and, the first end surface 101 is in contact with the third end surface 21 and the housing 10 is fixed on the image sensor carrying plate 20.

The moveable carrier 30 is positioned above the image sensor carrying plate 20 and includes a first surface 31, a second surface 32 opposites to the first surface 31, a first side surface 36, and a second side surface 37 close to the first side surface 36, and defines a receiving through hole 33 configured for receiving a lens module. The through hole 33 extends through the first surface 31 and the second surface 32. The inner surface of the receiving through hole 33 is provided with a number of screw threads 331, and the screw threads 331 is used for fixing the lens module.

The moveable carrier 30 further includes a first tab 301 and a second tab 302 spaced from the first tab 301. The first tab 301 corresponds to the second tab 302. The first tab 301 is located at a corner of the first surface 31, and the second tab 302 is located at a corner of the second surface 32. The first tab 301 defines a first bushing hole 341 and the second tab 302 defines a second bushing hole 342. The first bushing hole 341 is aligned with the second bushing hole 342. An interior diameter of the first bushing hole 341 is substantially equal to an interior diameter of the second bushing hole 342. The first bushing hole 341 and the second bushing hole 342 cooperatively form a bushing hole 34.

The moveable carrier 30 further defines a groove 343 between the first tab 301 and the second tab 302. The moveable carrier 30 includes a third side surface 345 in the groove 343 connecting the first side surface 36 to the second side surface 37.

The metal tube 35 is fixed in the bushing hole 34. Specifically, when the metal tube 35 is inserted into the first bushing hole 341 and the second bushing hole 342 and rotate the moveable carrier 30, and glue or adhesive is dispensed in the groove 343. The glue or adhesive flows into the clearance between the metal tube 35 and the first bushing hole 341 and the second bushing hole 342. In this way, the metal tube 35 is firmly fixed in place. The metal tube 35 defines a central hole 350. The central hole 350 receives the metallic guide pin 40. The length of the metal tube 35 is substantially equal to a thickness of the moveable carrier 30.

The metallic guide pin 40 includes a first end 41 and a second end 42 opposite to the first end 41. The second end 42 is fixed in the through hole 22 with adhesive, and the first end 41 is exposed from the metal tube 35 and positioned in the receiving hole 105. The clearance between the metallic guide pin 40 and the metal tube 35 is in a range from 3 μm˜5 μm. This clearance can realize an optimum auto-focus function.

The metal tube 35 is fixed in the bushing hole 34 of the camera actuator 100 in this disclosure and the metallic guide pin 40 is received in the metal tube 35. Therefore grinding between the moveable carrier 30 and the metallic guide pin 40 is reduced. Furthermore, plastic particles will not be formed and dropped into the image sensor carrying plate 20 because of the metal tube 35.

It is to be understood, however, that even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of portion within the principles of the disclosure to the full extent indicated by the broad general meaning of the terms in which the appended claims are expressed.

What is claimed is:

1. A camera actuator comprising:
an image sensor carrying plate;
a moveable carrier positioning above the image sensor carrying plate, the movable carrier comprising a first surface, a second surface opposite to the first surface, a first side surface, and a second side surface, and a receiving through hole extending through the first surface and the second surface, the receiving through hole configured for receiving a lens module, the moveable carrier further comprising a first tab and a second tab spaced from the first tab, the first tab located at a corner of the first surface, the second tab located at a corner of the second surface, the first tab defining a first bushing hole and the second tab defining a second bushing hole, the first bushing hole being aligned with the second bushing hole;
a metal tube extending through the first bushing hole and the second bushing hole, the metal tube;
the image sensor carrying plate comprising a through hole;
a metallic guide pin comprising a first end and a second end, the first end being fixed in the through hole, the second end being inserted into the metal tube.

2. The camera actuator of claim 1, wherein a length of the metal tube is equal to a thickness of the moveable carrier.

3. The camera actuator of claim 1, further comprising a housing receiving the moveable carrier therein, wherein the housing defines a hole in the center thereof.

4. The camera actuator of claim 3, wherein the housing comprises a first end surface and a second end surface opposite to the first end surface, the first end surface defines a plurality of recesses, and the second end surface defines a receiving hole is adjacent to the hole.

5. The camera actuator of claim 3, wherein the receiving hole is aligned with the through hole.

6. The camera actuator of claim 3, wherein the image sensor carrying plate comprises a third end surface, the third end surface comprises a plurality of protrusions extending from the third end surface, the protrusions engaged with the recesses.

7. The camera actuator of claim 1, wherein a clearance between the metallic guide pin and the metal tube is in a range from 3 μm to 5 μm.

8. The camera actuator of claim 1, wherein an interior diameter of the first bushing hole is equal to an interior diameter of the second bushing hole.

9. The camera actuator of claim 1, wherein an inner surface of the receiving through hole defines a screw thread.

10. The camera actuator of claim 1, wherein the moveable carrier further defines a groove extending between the first side surface and the second side surface.
